(19) United States
(12) Patent Application Publication
(10) Pub. No.: US 2011/0096266 A1
(43) Pub. Date: Apr. 28, 2011

(54) SYSTEM AND METHOD FOR PROVIDING BACKLIGHTING IN LIQUID CRYSTAL DISPLAY (LCD) DEVICES

(75) Inventor: Estill Thone Hall, Fishers, IN (US)

(73) Assignee: SHENZHEN TCL NEW TECHNOLOGY LTD., Shekou, Shenzhen, Guangdong (CN)

(21) Appl. No.: 12/996,324

(22) PCT Filed: Oct. 24, 2008
(86) PCT No.: PCT/US08/81161

§ 371 Date: Dec. 3, 2010

(30) Foreign Application Priority Data
Jun. 13, 2008 (CN) 200810067698.3

(51) Int. Cl. G02F 1/1337; G02F 1/1335

(52) U.S. Cl. 349/64; 362/97.2

(57) ABSTRACT

An exemplary display device is provided having increased brightness and light distribution uniformity, resulting in improved backlighting. The exemplary display device comprises a plurality of lamps arranged such that each of the lamps is substantially parallel with the others. The exemplary display device additionally comprises a holographic diffuser aligned so that a first diffusion axis diffuses light produced by the plurality of lamps in a first direction and a second diffusion axis diffuses light produced by the plurality of lamps in a second direction, the first direction being substantially perpendicular to the plurality of lamps and the second direction being substantially parallel to the plurality of lamps, wherein substantially more of the light produced by the plurality of lamps is diffused in the first direction. The diffusion of the light output produced by the plurality of lamps by the holographic diffuser creates the effect of a single uniform illumination source.

### FIELD OF THE INVENTION

The present invention relates generally to video display systems. More specifically, the present invention relates to the use of holographic diffusers to provide backlighting in liquid crystal display (LCD) video systems.

### BACKGROUND

This section is intended to introduce the reader to various aspects of art which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Many video display units create video images by using a light source to illuminate an image displayed on a panel. One example of such a video display unit is a liquid crystal display (LCD) system, which uses a backlight to illuminate an image that is displayed on an LCD panel. In particular, large LCD TVs generally employ backlighting as a form of illumination, which may be provided by a number of long narrow cold cathode fluorescent lamps (CCFLs), or alternatively, hot cathode fluorescent lamps (HCFLs), forming a lamp plane array. However, the light distribution from multiple lamps is not uniform when applied to the LCD panel. For example, from the perspective of a viewer, a non-uniform light distribution results in some areas of the LCD panel appearing brighter than other areas. This is generally an undesirable characteristic in video image quality.

The current art employs several methods for increasing the uniformity of light distribution in LCD devices. One solution to reduce the problems related to uneven lighting is to first diffuse the light output from the multiple light sources through an optical diffuser, typically glass, in order to more uniformly distribute the light source in as small a space as possible before applying the light to the LCD panel. Another solution for increasing light distribution uniformity is by decreasing the spacing between each lamp, thus requiring additional lamps. In addition, a light pipe layer may be employed between the lamp plane and the diffuser in order to conduct and distribute light in a more desirable way prior to diffusion. Disadvantageously, the aforementioned methods require integrating additional components (e.g., the additional lamps and light pipe layer, etc.), thus increasing the manufacturing and production costs of the LCD device. Another method for increasing light distribution uniformity is by increasing the distance between the lamps and the diffuser. However, this results in a thicker LCD which may result in a less attractive product in the eyes of a consumer (a thicker LCD device may be deemed inferior when compared alongside thinner competing LCD products).

To avoid the drawbacks of the prior art, there is a need for an LCD display system having improved light distribution uniformity without sacrificing economic and market competitiveness.

### BRIEF DESCRIPTION OF THE DRAWINGS

These and other features, aspects, and advantages of the present technique will become better understood when the following detailed description is read with reference to the accompanying drawings in which like characters represent like parts throughout the drawings, wherein:

FIG. 1 is a block diagram of an electronic device that may employ an LCD display in accordance with an exemplary embodiment of the present invention;

FIG. 2 is a diagram showing a configuration of a plurality of lamps 22 in an LCD panel in accordance with an exemplary embodiment of the present invention;

FIG. 3 is a cross sectional view of an LCD panel in accordance with an exemplary embodiment of the present invention;

FIG. 4 is a perspective view illustrating the diffusion of light in the LCD panel of FIG. 3 in accordance with an exemplary embodiment of the present invention; and

FIG. 5 is a process flow diagram illustrating a method in accordance with an exemplary embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

An exemplary embodiment of the present invention provides a holographic optical diffuser (holographic diffuser) for improving uniformity of light distribution in LCD backlighting. Holographic diffusers provide a high level of diffusion transmission efficiency and can be used to control the diffuse area of illumination from various light sources. For example, some holographic diffusers are capable of providing a diffusion transmission efficiency of 90% or greater.

In one exemplary embodiment, glass diffusers of conventional LCD panel devices are replaced with a holographic diffuser that is aligned so that a strong diffusion axis is orthogonal to the direction of the backlight lamps, and a weak diffusion axis is parallel to the direction of the backlight lamps. As such, the light output is diffused strongly along the orthogonal diffusion axis in the direction necessary to “smear” the lamp images together, creating the effect of a uniform illumination source. Furthermore, because only a relatively small amount of the light output is diffused along the weak diffusion axis, there is decreased loss of the useful light output in the direction parallel to the lamps and, therefore, the overall brightness of the backlight is increased.

The application of a holographic diffuser to provide improved uniformity in LCD backlighting is advantageous in several ways. As discussed above, holographic diffusers are more efficient than other conventional diffusers and, therefore, more light is available for illumination of the LCD panel. This may reduce or eliminate the need for additional components (e.g., the additional lamps and light pipe layer, etc.), thereby reducing the overall cost of manufacturing the LCD device. Moreover, in a manufacturing context, the benefits of the holographic diffuser can be utilized in several ways:

(1) the distance between the lamp plane and the diffuser can be decreased while maintaining uniformity, thereby allowing for a thinner LCD panel;

(2) the distance between each lamp can be increased while maintaining uniformity, thereby reducing the number of lamps in the lamp plane and lowering production costs;

(3) the distance between the lamp and diffuser can be maintained with improved backlight illumination uniformity; and

(4) the distance between each lamp can be maintained with improved backlight illumination uniformity.

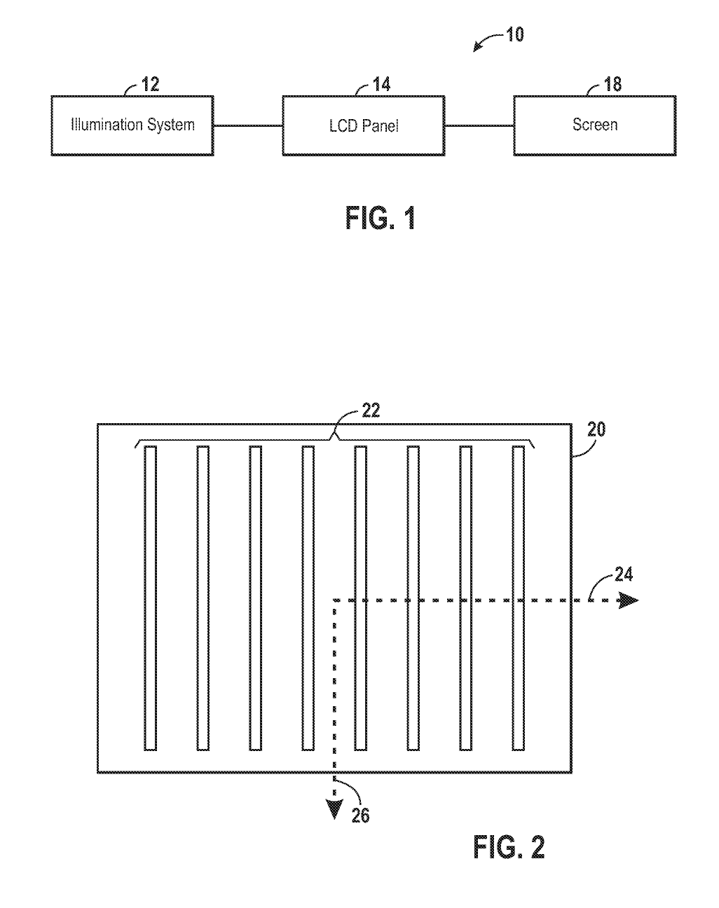

Turning to FIG. 1, a block diagram of a display device in accordance with one embodiment of the present invention is illustrated and generally designated by reference numeral 10. In the illustrated embodiment, the display device 10 may include a liquid crystal display (LCD) display unit, such as a television unit, laptop unit, or the like. Those of ordinary skill in the art will appreciate that the various functional blocks shown in FIG. 1 may comprise hardware elements (including circuitry), software elements (including computer code stored on a machine-readable medium) or a combination of both hardware and software elements.

Specifically, in the illustrated embodiment, the display device 10 includes an illumination system 12, an LCD panel 14, and a screen 18. The illumination system 12 is adapted to generate white or colored light to provide a backlight for the LCD panel 14 and the screen 18. The illumination system 12 may include any suitable form of lamp or bulb capable of producing white or generally white light. In the illustrated embodiment, the illumination system 12 may include a plurality of cold cathode fluorescent (CCFL) lamps forming a lamp plane. In other embodiments of the present invention, hot cathode fluorescent (HCFL) lamps may be used in place of CCFL lamps. Furthermore, in one or more embodiments utilizing a plurality of either CCFL or HCFL lamps, the CCFL or HCFL lamps may be arranged in such a manner that each of the plurality of lamps is parallel with the others. It will be appreciated, however, that the above-described exemplary embodiments are not intended to be exclusive, and that in alternate embodiments, other suitable lighting sources (e.g., light emitting diodes, incandescent light bulbs or the like) may also be employed in the illumination system 12.

The LCD panel 14 is adapted to intake and modulate the light provided by the illumination system 12, thereby forming viewable images which are, thereafter, distributed and displayed across the screen 18. In the illustrated embodiment, the LCD panel 14 includes a holographic optical diffuser adapted to diffuse or spread the light produced by the illumination system 12. As will be appreciated by those skilled in the art, the holographic diffuser may be capable of providing a diffusion transmission efficiency of 90% or greater. The holographic diffuser is aligned so that a first diffusion axis diffuses a substantial portion of the light in a direction that is perpendicular to the direction of the light source of the illumination system 12 (e.g., perpendicular to the direction of a plurality of CCFLs), and a second diffusion axis diffuses a relatively small amount of the light weakly in the same direction of the light source (e.g, parallel to a plurality of CCFLs). From the perspective of a viewer, the the diffusion of the light output from the illumination system 12 by the holographic diffuser of the LCD panel 14 creates the effect of a uniformly distributed illumination source, which is then applied onto the screen 18 to provide properly diffused backlighting for the screen 18. The configuration of the lighting source of the illumination system 12 and operation of the holographic diffuser will be described in more detail below.

In one or more exemplary embodiments of the present invention, the LCD panel 14 may further include a light pipe layer operatively positioned between the illumination system 12 and the holographic diffuser. For example, the light pipe layer may be adapted to funnel or conduct the light output from the illumination system 12 in a more desirable way prior to diffusion by the holographic diffuser.

The LCD panel 14 may include additional imaging components adapted to generate and enhance images appearing on the screen 18. Such imaging components may include a thin film transistor (TFT) LCD, super twisted nematic (STN) LCD, multidomain vertical alignment (MVA) LCD, pattern vertical alignment (PVA) LCD or the like. An LCD device may generally include two thin polarized panels on either side of a thin liquid-crystal gel that is divided into pixels. In the illustrated embodiment, images may be formed by the display unit 10 as the LCD panel 14 applies appropriate voltages to appropriate image pixels disposed across the panel 14, wherein each pixel is be adapted to receive a respective voltage and to darken in proportion to the amount of voltage applied. By way of example, to create a bright detail, a low voltage is applied to the corresponding pixels and, conversely, for darker shadow details, a higher voltage is applied. In this manner, the uniformly distributed light output provided by the LCD panel 14 is provided to the screen 18, so as to from images perceivable by a viewer. The opacity of each pixel on the LCD panel 14 determines the amount of light that passes through. It should be noted that LCDs are not completely opaque and that even the darkest (e.g., blackest) pixels may still allow some degree of light to pass through.

FIG. 2 is a diagram showing a configuration of a plurality of lamps 22 in an LCD panel, such as the LCD panel 14 (FIG. 1) in accordance with an exemplary embodiment of the present invention. As discussed above, the plurality of lamps 22 may include a plurality of CCFLs forming a lamp plane 20. In the illustrated embodiment, the plurality of lamps 22 is arranged in such a manner that each of the plurality of lamps 22 is parallel with the others. The light output from the lamp plane 20 is diffused by a holographic diffuser (not shown in FIG. 2). In order to achieve a uniform light distribution, the holographic diffuser is adapted to diffuse a substantial portion of the light output from lamp plane 20 along a first diffusion axis in a first direction 24 that is perpendicular to the plurality of lamps 22. Additionally, the holographic diffuser is adapted to diffuse a relatively small portion of the light output from the lamp plane 20 weakly along a second diffusion axis in a second direction 26 that is parallel to the direction of the plurality of lamps 22.

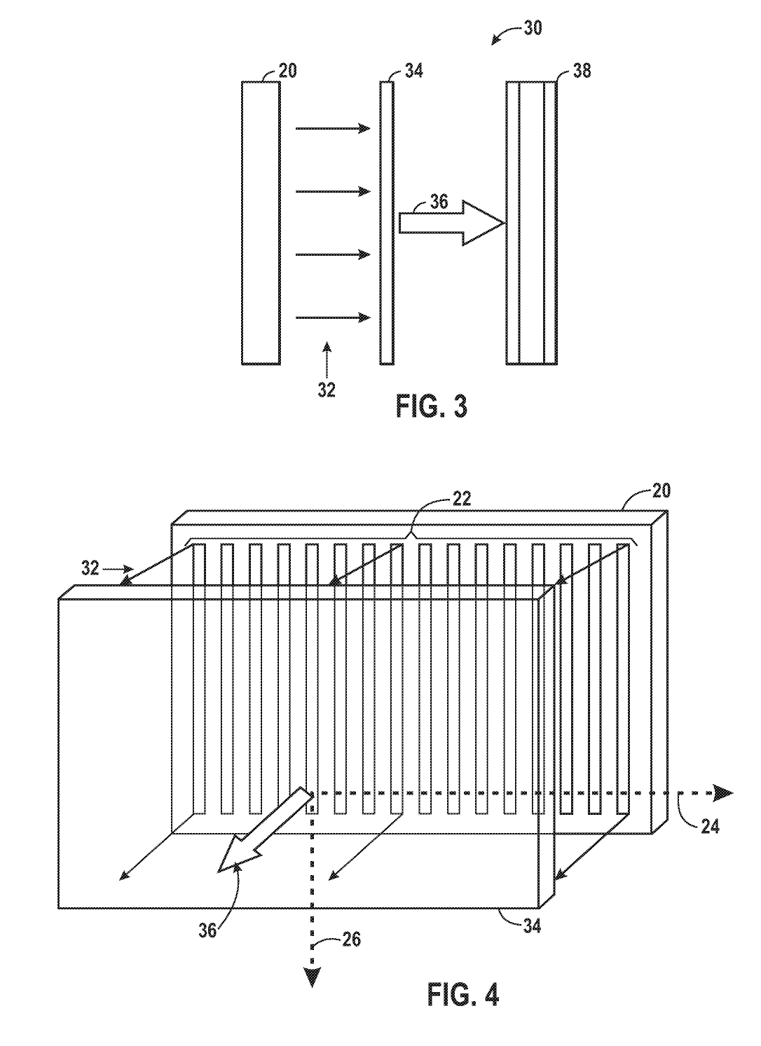

FIG. 3 is a cross sectional view of an LCD panel in accordance with an exemplary embodiment of the present invention. The LCD panel is generally referred to by reference numeral 30. In the illustrated embodiment, the LCD panel 30 includes a lamp plane 20 (also shown in FIG. 2), a holographic diffuser 34, and an LCD 38. The lamp plane 20 may include a plurality of lamps 22 (FIG. 2). The light produced by each of the plurality of lamps 22 (FIG. 2) may result in a non-uniform light output, generally referred to by reference numeral 32. In order to more uniformly distribute the non-uniform light output 32, a holographic diffuser 34 is operatively positioned between the lamp plane 20 and the LCD 38. The non-uniform light output 32 is diffused by the holographic diffuser 34 in order to produce a uniformly distributed light output 36. As described above, the holographic diffuser 34 is adapted to diffuse a substantial portion of the non-uniform light output 32 in a first direction 24 (FIG. 2) along a first diffusion axis that is perpendicular to the plurality of lamps 22 (FIG. 2) of the lamp plane 20, and to diffuse a relatively small amount of the non-uniform light output 32 weakly in a second direction 26 (FIG. 2) along a second diffusion axis that is parallel to the direction of the plurality of lamps 22 (FIG. 2) of the lamp plane 20. The diffusion of the non-uniform light output 32 by the holographic diffuser 34 produces a uniformly distributed light output 36 which provides uniform backlighting for displaying video images on the LCD 38.

In one or more exemplary embodiments of the present invention, the LCD panel 30 may further include a light pipe layer (not shown in FIG. 3) operatively positioned between the lamp plane 20 and the holographic diffuser 34. The light pipe layer is adapted to funnel or conduct the non-uniform light output 32 from the plurality of lamps 22 (FIG. 2) in the lamp plane 20 in a more desirable way prior to diffusion by the holographic diffuser 34.

FIG. 4 is a perspective view illustrating the diffusion of light in the LCD panel of FIG. 3 in accordance with an exemplary embodiment of the present invention. Specifically, FIG. 4 illustrates the diffusion of the non-uniform light output 32 from the lamp plane 20 through the holographic diffuser 34. As discussed above with regards to FIG. 2, the lamp plane 20 may include a plurality of lamps 22, which may be provided by CCFLs or, in the alternative, HCFLs, the light produced by each of the plurality of of lamps 22 resulting in a non-uniform light output 32. The holographic diffuser 34 is adapted to diffuse the non-uniform light output 32 from the plurality of lamps 22 in order to produce a uniformly distributed light output 36. As described above, the holographic diffuser 34 is adapted to diffuse a substantial portion of the non-uniform light output 32 in a first direction 24 that is perpendicular to the plurality of lamps 22 of the lamp plane 20, and to diffuse a relatively small amount of the non-uniform light output 32 weakly in a second direction 26 that is parallel to the direction of the plurality of lamps 22 of the lamp plane 20. The diffusion of the non-uniform light output 32 by the holographic diffuser 34 in the manner described herein creates the effect of a uniformly distributed light output 36 which provides uniform backlighting for the LCD 38 (FIG. 3). From the perspective of a viewer, the light output from each of the plurality of lamps 22 is smeared together by the holographic diffuser 34 to create the effect of a single uniform illumination source.

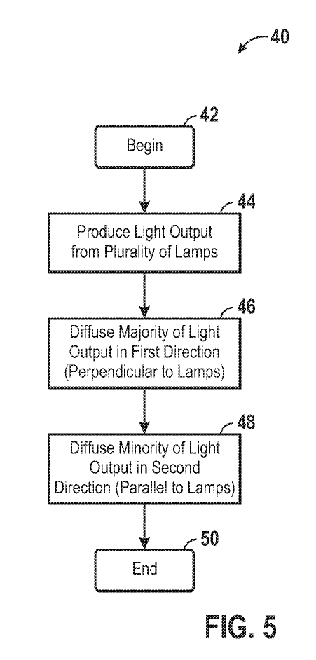

FIG. 5 is a process flow diagram illustrating a method for operating a display device 10 (FIG. 1) in accordance with an exemplary embodiment of the present invention. The process is generally referred to by the reference number 40. At block 42, the process begins.

As discussed above, a display device 10 (FIG. 1) may include a plurality of lamps 22 (FIG. 2). At block 44, a non-uniform light output 32 (FIG. 4) is produced by the plurality of lamps 22 (FIG. 4). As discussed above, the plurality of lamps 22 (FIG. 4) may include a plurality of CCFLs or HCFLs, arranged such that each of the plurality of lamps (22) (FIG. 4) is substantially parallel with the others. A substantial majority of the light output 32 (FIG. 4) is diffused in a first direction 24 (FIG. 4), the first direction 24 (FIG. 4) being perpendicular to the plurality of lamps 22 (FIG. 4), as illustrated at block 46. Further, a substantial minority of the light light output 32 (FIG. 4) is diffused in a second direction 26 (FIG. 4), the second direction 26 (FIG. 4) being parallel to the plurality of lamps 22 (FIG. 4), as illustrated at block 48.

The diffused light output 36 (FIG. 4) creates the effect, from the perspective of a viewer, of a single uniform illumination source, which may be projected onto a screen 18 (FIG. 1). As discussed above, the diffusion of the non-uniform light output 32 (FIG. 4) may be accomplished by a holographic diffuser 34 (FIG. 4). As will be appreciated by those skilled in the art, the holographic diffuser 34 (FIG. 4) may be capable of providing a diffusion transmission efficiency of 90% or greater. The process 40 ends at block 50.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A display device, comprising:
a plurality of lamps arranged so that each of the plurality of lamps is substantially parallel with the others; and
a holographic diffuser having a first diffusion axis that diffuses light produced by the plurality of lamps in a first direction and a second diffusion axis that diffuses light produced by the plurality of lamps in a second direction, the first direction being substantially perpendicular to the plurality of lamps and the second direction being substantially parallel to the plurality of lamps, wherein substantially more of the light produced by the plurality of lamps is diffused in the first direction.

2. The display device of claim 1, wherein the plurality of lamps includes a plurality of cold cathode fluorescent (CCFL) lamps.

3. The display device of claim 1, wherein the plurality of lamps includes a plurality of hot cathode fluorescent (HCFL) lamps.

4. The display device of claim 1, further comprising a liquid crystal display (LCD) adapted to display an image.

5. The display device of claim 4, further comprising imaging components adapted to generate one or more images on the LCD.

6. The display device of claim 5, wherein light produced by the plurality of lamps and diffused by the holographic diffuser is projected onto the LCD to provide backlighting for displaying the one or more images generated by the LCD .

7. The display device of claim 6, wherein the backlighting has a substantially uniform light distribution.

8. The display device of claim 1, wherein the holographic diffuser has a diffusion transmission efficiency of at least 90 percent.

9. The display device of claim 1, further comprising a light pipe layer adapted to conduct light produced by the plurality of lamps.

10. The display device of claim 9, wherein the light pipe layer is operatively positioned between the plurality of lamps and the holographic diffuser, and wherein the light pipe layer conducts light produced by the plurality of lamps from the plurality of lamps to the holographic diffuser.

11. A method of operating a display device having a plurality of lamps arranged so that each of the plurality of lamps is substantially parallel with the others, the method comprising:
producing light from the plurality of lamps;
diffusing a substantial majority of the light produced by the plurality of lamps in a first direction substantially perpendicular to the plurality of lamps; and
diffusing a substantial minority of the light produced by the plurality of lamps in a second direction substantially parallel to the plurality of lamps.

12. The method of claim 11, wherein diffusing the substantial majority of light and the substantial minority of light produced by the plurality of lamps is performed with a holographic diffuser.

13. The method of claim 12, wherein the holographic diffuser has a diffusion transmission efficiency of at least 90 percent.

14. The method of claim 12, wherein diffusing the substantial majority of the light and the substantial minority of light produced by the plurality of lamp further comprises first conducting the substantial majority of light and the substantial minority of light produced by the plurality of lamps through a light pipe layer.

15. The method of claim 14, wherein the light pipe layer is operatively positioned between the plurality of lamps and the holographic diffuser.

16. The method of claim 11, wherein the plurality of lamps includes a plurality of cold cathode fluorescent (CCFL) lamps.

17. The method of claim 11, wherein the plurality of lamps includes a plurality of hot cathode fluorescent (HCFL) lamps.

18. The method of claim 12, further comprising projecting the substantial majority of light and substantial minority of light produced by the plurality of lamps and diffused by the holographic diffuser onto a screen.

19. The method of claim 18, wherein the display device includes an LCD device.

20. A display device having a plurality of lamps arranged so that each of the plurality of lamps is parallel with the others, the display device, comprising:
means for diffusing a substantial majority of light produced by the plurality of lamps in a first direction substantially perpendicular to the plurality of lamps; and
means for diffusing a substantial minority of light produced by the plurality of lamps in a second direction substantially parallel to the plurality of lamps.
